(19) United States
(12) Patent Application Publication
(10) Pub. No.: US 2014/0152220 A1
(43) Pub. Date: Jun. 5, 2014

(54) MOTOR DRIVING CONTROL APPARATUS AND METHOD, AND MOTOR USING THE SAME

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/772,113

(22) Filed: Feb. 20, 2013

(30) Foreign Application Priority Data
Nov. 30, 2012 (KR) 10-2012-0137866

(51) Int. Cl. H02P 6/18

(52) U.S. Cl. CPC H02P 6/182
USPC 318/400.35

(57) ABSTRACT

There are provided a motor driving control apparatus and method and a motor using the same. The motor driving control apparatus includes: a back-electromotive force detecting unit detecting back-electromotive force of a motor apparatus; a gradient calculating unit calculating a gradient of a waveform of the detected back-electromotive force; and a controlling unit calculating a zero-crossing point of the back-electromotive force using the calculated gradient and controlling driving of the motor apparatus using the calculated zero-crossing point.

### CROSS-REFERENCE TO RELATED APPLICATIONS

This application claims the priority of Korean Patent Application No. 10-2012-0137866 filed on Nov. 30, 2012, in the Korean Intellectual Property Office, the disclosure of which is incorporated herein by reference.

### BACKGROUND OF THE INVENTION

1. Field of the Invention

The present invention relates to a motor driving control apparatus and method capable of more accurately performing driving of a motor by calculating a gradient of a waveform of back-electromotive force by integration and calculating a zero-crossing point of the back-electromotive force using the calculated gradient, and a motor using the same.

2. Description of the Related Art

In accordance with the development of motor technology, motors having various sizes have been used in a wide range of technological fields.

Generally, a motor is driven by allowing a rotor to be rotated by a permanent magnet and a coil having polarities changed according to current applied thereto. Initially, a brush type motor in which a rotor is provided with a coil was provided. However, this brush type motor has a problem such as brush abrasion, spark generation, and the like, during the driving of the motor.

Therefore, recently, various types of brushless motors have been in general use. In the brushless motor, a permanent magnet is used as a rotor and a plurality of coils are provided as a stator to induce rotation of the rotor.

In the case of the brushless motor as described above, it is necessary to recognize a position of the rotor. To this end, a scheme of using back-electromotive force (BEMF) has been widely used.

However, in the case of the scheme of using the back-electromotive force, it may be difficult to accurately calculate a zero-crossing point of the back-electromotive force.

Particularly, since a driving control signal such as a pulse width modulation (PWM) signal, or the like, may be mixed with the back-electromotive force, it may be difficult to accurately calculate the zero-crossing point.

The following Related Art Documents, relating to a brushless motor, have a limitation in that a zero-crossing point of back-electromotive force may not be accurately calculated.

Further, in the case of the following Related Art Documents, circuitry for calculating the zero-crossing point of the back-electromotive force is more complicated, such that it may be difficult to rapidly and accurately calculate the zero-crossing point of the back-electromotive force.

### RELATED ART DOCUMENTS

(Patent Document 1) Korean Patent No. 10-1041076
(Patent Document 2) Korean Patent No. 10-0174492

### SUMMARY OF THE INVENTION

An aspect of the present invention provides a motor driving control apparatus and method capable of more accurately performing driving of a motor by calculating a gradient of a waveform of back-electromotive force by integration and calculating a zero-crossing point of the back-electromotive force using the calculated gradient, and a motor using the same.

According to an aspect of the present invention, there is provided a motor driving control apparatus including: a back-electromotive force detecting unit detecting back-electromotive force of a motor apparatus; a gradient calculating unit calculating a gradient of a waveform of the detected back-electromotive force; and a controlling unit calculating a zero-crossing point of the back-electromotive force using the calculated gradient and controlling driving of the motor apparatus using the calculated zero-crossing point.

The gradient calculating unit may include: a filter removing a driving control signal from the back-electromotive force; and an integrator integrating the filtered back-electromotive force provided from the filter for a predetermined time to calculate the gradient.

The integrator may calculate the gradient using the following Equation:

$$Vintegral = {\int }_{0}^{t} - ax + V d c = {[ - \frac{{ax}^{2}}{2} + V d cx ]}_{0}^{t} .$$

The integrator may not calculate the gradient when the filtered back-electromotive force is periodically increased and decreased for the predetermined time.

The controlling unit may include a zero-crossing determinator applying the gradient to an initial voltage level and determining a point at which a voltage level is equal to ½ of the initial voltage level as the zero-crossing point.

The controlling unit may further include a delay adder adding a time delay generated due to filtering performed by the gradient calculating unit to the zero-crossing point.

The motor driving control apparatus may further include a driving signal generating unit generating a driving control signal of the motor apparatus according to the controlling of the controlling unit, wherein the controlling unit may control the driving signal generating unit to perform phase commutation according to the zero-crossing point.

According to another aspect of the present invention, there is provided a motor including: a motor apparatus performing a rotation operation according to a driving control signal; and a motor driving control apparatus providing the driving control signal to the motor apparatus to control driving of the motor apparatus, wherein the motor driving control apparatus calculates a zero-crossing point of back-electromotive force using a gradient of a waveform of the back-electromotive force detected in the motor apparatus and generates the driving control signal using the calculated zero-crossing point.

The motor driving control apparatus may include: a back-electromotive force detecting unit detecting the back-electromotive force of the motor apparatus; a gradient calculating unit calculating the gradient of the waveform of the detected back-electromotive force; and a controlling unit calculating the zero-crossing point of the back-electromotive force using the calculated gradient and controlling the driving of the motor apparatus using the calculated zero-crossing point.

The gradient calculating unit may include: a filter removing the driving control signal from the back-electromotive force; and an integrator integrating the filtered back-electromotive force provided from the filter for a predetermined time to calculate the gradient.

The integrator may calculate the gradient using the following Equation:

$$Vintegral = {\int }_{0}^{t} - ax + V d c = {[ - \frac{{ax}^{2}}{2} + V d cx ]}_{0}^{t} .$$

The controlling unit may include a zero-crossing determinator applying the gradient to an initial voltage level and determining a point at which a voltage level is equal to ½ of the initial voltage level as the zero-crossing point.

According to another aspect of the present invention, there is provided a motor driving control method performed by a motor driving control apparatus controlling driving of a motor apparatus, the motor driving control method including: detecting back-electromotive force of the motor apparatus; calculating a gradient of a waveform of the detected back-electromotive force; and calculating a zero-crossing point of the back-electromotive force using the calculated gradient and controlling the driving of the motor apparatus using the calculated zero-crossing point.

The calculating of the gradient may include: performing filtering for removing a driving control signal from the back-electromotive force; and integrating the filtered back-electromotive force for a predetermined time to calculate the gradient.

The integrating of the filtered back-electromotive force may include calculating the gradient using the following Equation:

$$Vintegral = {\int }_{0}^{t} - ax + V d c = {[ - \frac{{ax}^{2}}{2} + V d cx ]}_{0}^{t} .$$

The integrating of the filtered back-electromotive force may include allowing the gradient not to be calculated when the filtered back-electromotive force is periodically increased and decreased for the predetermined time.

The controlling of the driving of the motor apparatus may include applying the gradient to an initial voltage level and determining a point at which a voltage level is equal to ½ of the initial voltage level as the zero-crossing point.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating an example of a motor driving control apparatus;

FIG. 2 is a configuration diagram illustrating an example of a motor driving control apparatus according to an embodiment of the present invention;

FIG. 3 is a detailed configuration diagram illustrating an example of a gradient calculating unit according to the embodiment of the present invention;

FIGS. 4 and 5 are detailed configuration diagrams illustrating an example and another example of a controlling unit according to the embodiment of the present invention;

FIG. 6 is a graph illustrating a phase voltage and actual back-electromotive force of a motor apparatus;

FIG. 7 is a reference diagram illustrating a technology of calculating a gradient according to the embodiment of the present invention;

FIG. 8 is a flowchart illustrating an example of a motor driving control method according to an embodiment of the present invention; and

FIGS. 9 and 10 are detailed flowcharts illustrating examples of the motor driving control method according to the embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like components.

Hereinafter, for convenience of explanation, the present invention will be described based on a brushless motor. However, it is obvious that the scope of the present invention is not necessarily limited to the brushless motor.

In addition, hereinafter, a motor itself will be referred to as a motor apparatus 20 or 200, and an apparatus including a motor driving control apparatus 10 or 100 for driving the motor apparatus 20 or 200 and the motor apparatus 20 or 200 will be referred to as a motor.

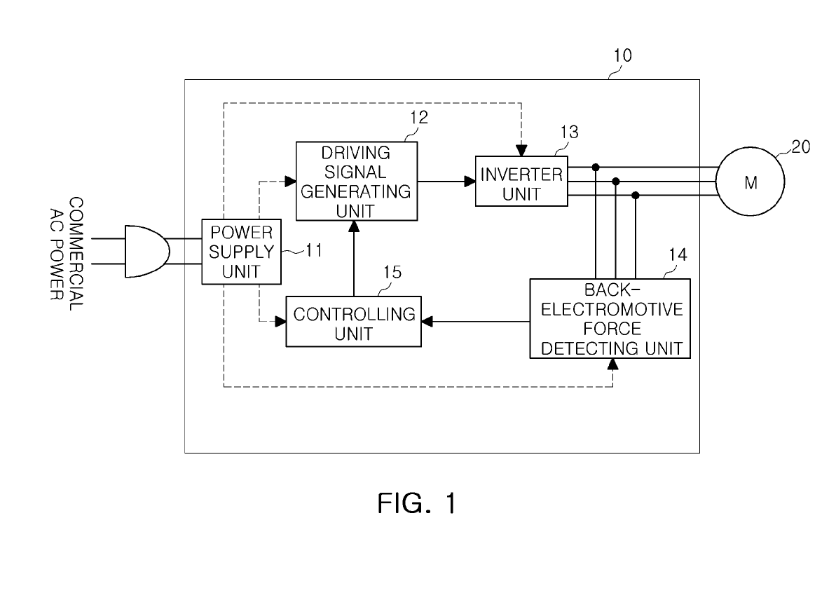

FIG. 1 is a configuration diagram illustrating an example of a motor driving control apparatus.

Referring to FIG. 1, the motor driving control apparatus 10 may include a power supply unit 11, a driving signal generating unit 12, an inverter unit 13, a back-electromotive force detecting unit 14, and a controlling unit 15.

The power supply unit 11 may supply power to respective components of the motor driving control apparatus 10. For example, the power supply unit 11 may convert commercial alternate current (AC) voltage into direct current (DC) voltage and supply the DC voltage to the respective components. In the example shown in FIG. 1, a dotted line means that predetermined power is supplied from the power supply unit 11.

The driving signal generating unit 12 may provide a driving control signal to the inverter unit 13. In the embodiment of the present invention, the driving control signal may be a pulse width modulation (PWM) signal.

The inverter unit 13 may control an operation of the motor apparatus 20. For example, the inverter unit 13 may convert the DC voltage into a multi-phase (for example, a three-phase or a four-phase) according to the driving control signal and apply the multi-phase voltage to respective coils (not shown) of the motor apparatus 20.

The back-electromotive force detecting unit 14 may detect back-electromotive force of the motor apparatus 20.

The controlling unit 15 may control the driving signal generating unit 12 to generate the driving control signal using the back-electromotive force provided from the back-electromotive force detecting unit 14. For example, the controlling unit 15 may control the driving signal generating unit 120 to perform phase commutation at a zero-crossing point of the back-electromotive force.

The motor apparatus 20 may perform a rotation operation according to the driving control signal. For example, the motor apparatus 20 may generate magnetic fields in the respective coils (stator) of the motor apparatus 20 by currents provided by the inverter unit 130 and flowing in the respective phases. The rotor (not shown) included in the motor apparatus 200 may be rotated by the magnetic fields generated in the respective coils as described above.

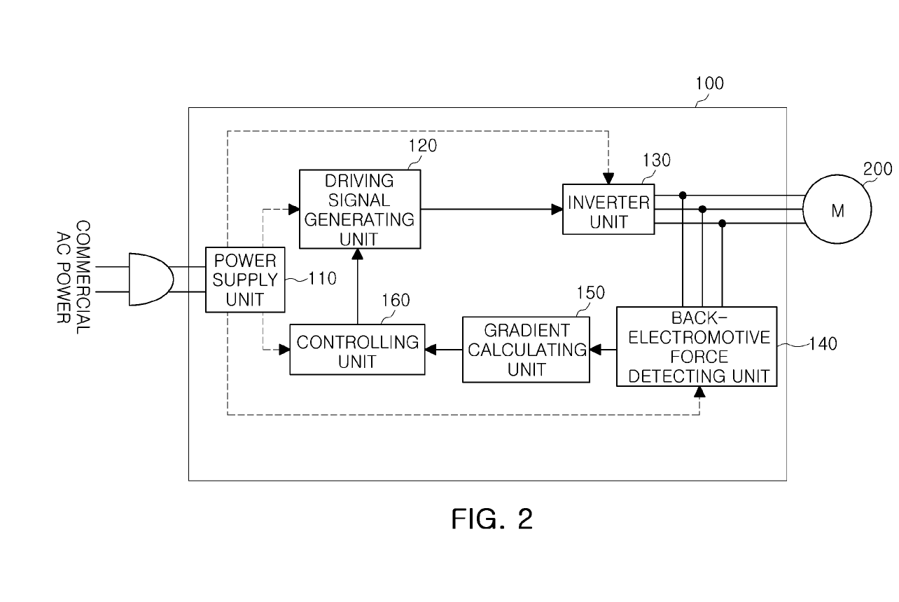

Hereinafter, various embodiments of the present invention will be described with reference to FIGS. 2 through 10.

In a description of various embodiments of the present invention to be provided below, an overlapped description of contents the same as or corresponding to the contents described above with reference to FIG. 1 will be omitted. However, those skilled in the art may clearly understand detailed contents of the present invention from the above-mentioned description.

FIG. 2 is a configuration diagram illustrating an example of a motor driving control apparatus according to an embodiment of the present invention.

Referring to FIG. 2, the motor driving control apparatus 100 may include a power supply unit 110, a driving signal generating unit 120, an inverter unit 130, a back-electromotive force detecting unit 140, a gradient calculating unit 150, and a controlling unit 160.

The power supply unit 110 may supply power to respective components of the motor driving control apparatus 100.

The driving signal generating unit 120 may generate a driving control signal for the motor apparatus 200 according to a control of the controlling unit 160. For example, the driving signal generating unit 120 may generate a pulse width modulation signal (hereinafter, referred to as a PWM signal) having a predetermined duty ratio and provide the PWM signal to the inverter unit 130 to allow the motor apparatus 200 to be driven.

The inverter unit 130 may receive the driving control signal to drive the motor apparatus 200.

The back-electromotive force detecting unit 140 may detect back-electromotive force generated in the motor apparatus 200.

In the embodiment of the present invention, in the case in which a neutral point of the motor apparatus 200 is exposed, the back-electromotive force detecting unit 140 may be electrically connected to the neutral point to detect the back-electromotive force.

In another embodiment of the present invention, in the case in which the neutral point of the motor apparatus 200 is not exposed, the back-electromotive force detecting unit 140 may detect the back-electromotive force using a virtual neutral point connecting the respective phases of the motor apparatus 200 to one another.

The gradient calculating unit 150 may calculate a gradient of a waveform of the detected back-electromotive force.

In the embodiment of the present invention, the gradient calculating unit 150 may integrate the detected back-electromotive force to calculate the gradient thereof.

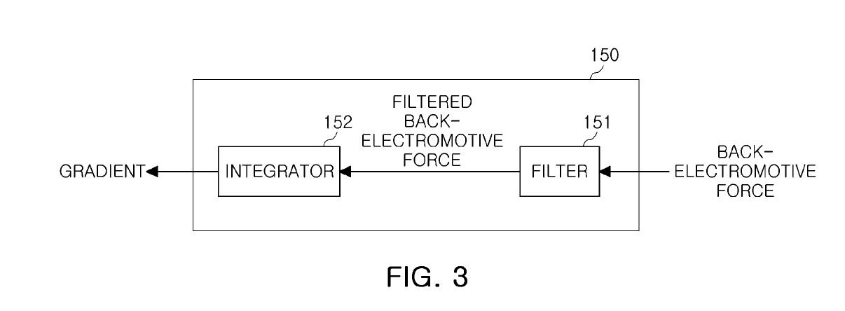

Specific examples of the gradient calculating unit 150 as described above will be described below in more detail with reference to FIG. 3.

The controlling unit 160 may calculate a zero-crossing point of the back-electromotive force using the gradient calculated by the gradient calculating unit 150 and control driving of the motor apparatus 200 using the calculated zero-crossing point.

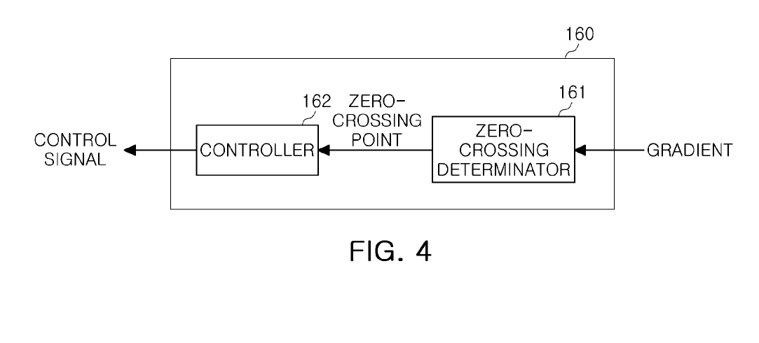

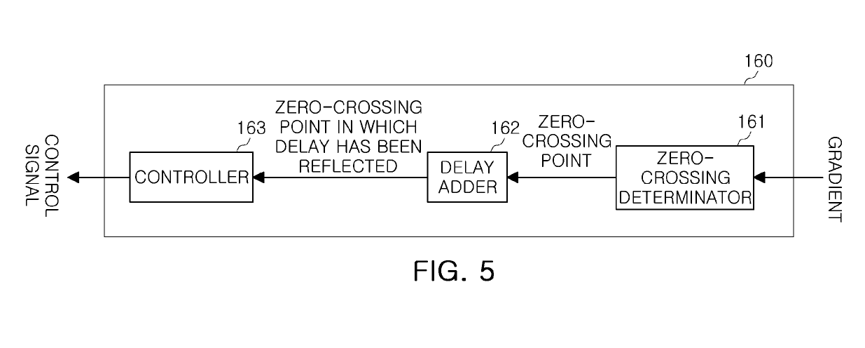

Specific examples of the controlling unit 160 as described above will be described in more detail with reference to FIGS. 4 and 5.

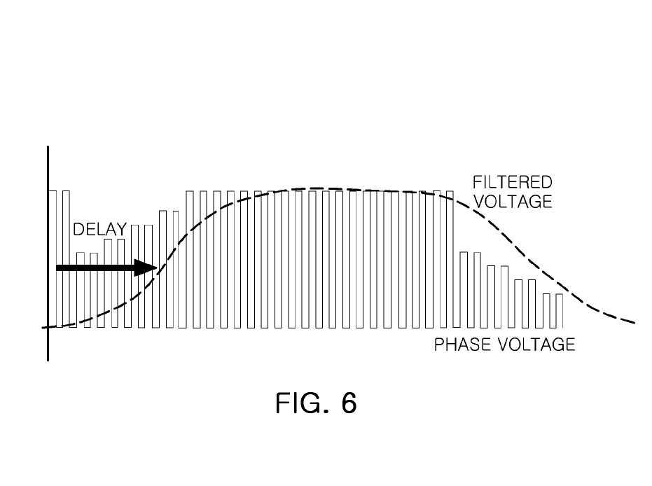

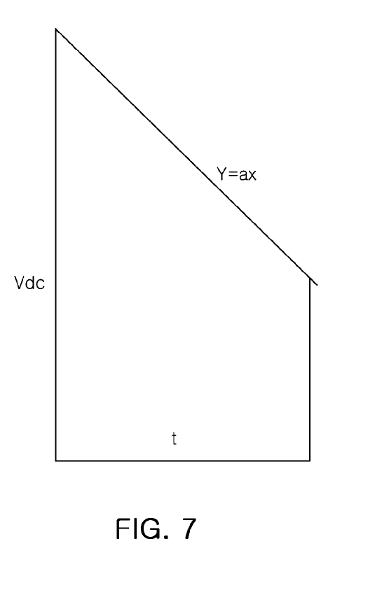

FIG. 3 is a detailed configuration diagram illustrating an example of the gradient calculating unit according to the embodiment of the present invention; FIG. 6 is a graph illustrating a phase voltage and actual back-electromotive force of the motor apparatus; and FIG. 7 is a reference diagram illustrating a technology of calculating a gradient according to the embodiment of the present invention.

Hereinafter, the gradient calculating unit 150 according to the embodiment of the present invention will be described in more detail with reference to FIGS. 3, 6 and 7.

In the embodiment of the present invention shown in FIG. 3, the gradient calculating unit 150 may include a filter 151 and an integrator 152.

The filter 151 may perform filtering for removing a PWM signal from the detected back-electromotive force. For example, the filter 151 may be a low pass filter filtering a PWM signal band. FIG. 6 shows a phase voltage and a filtered voltage. As shown in FIG. 6, it may be appreciated that the filtered voltage has a gradient corresponding to the phase voltage.

The integrator 152 may integrate the detected back-electromotive force for a predetermined time to calculate a gradient of a waveform of the back-electromotive force. According to the embodiment of the present invention, in the case in which the filter 151 is present, the integrator 152 may integrate the filtered back-electromotive force provided from the filter 151 to calculate the gradient.

In the embodiment of the present invention, the integrator 152 may perform the integration using the following Equation 1:

$$Vintegral = {\int }_{0}^{t} - ax + V d c = {[ - \frac{{ax}^{2}}{2} + V d cx ]}_{0}^{t} \qquad Equation 1$$

where Vdc refers to an initial level of a gradient of a waveform of back-electromotive force, and a refers to a gradient. In this embodiment, since Vdc and time t are known values, the integrator 152 may calculate the gradient through very simple calculation. Therefore, the integrator 152 may be very simply configured in spite of performing the predetermined integration. As a result, time efficiency improvement in the integration may be achieved.

In the embodiment of the present invention, the integrator 152 may perform integration on at least a portion of a section in which the waveform of the back-electromotive force has a constant gradient. The section in which the integration is performed may be simply illustrated as shown in FIG. 7.

In the embodiment of the present invention, the integrator 152 may not calculate a gradient with respect to a section in which the filtered back-electromotive force is periodically increased and decreased for a predetermined time, since a constant gradient is not calculated in the corresponding section.

FIG. 4 is a detailed configuration diagram illustrating an example of the controlling unit according to the embodiment of the present invention, and FIG. 5 is a detailed configuration diagram illustrating another example of the controlling unit according to the embodiment of the present invention.

Referring to the example of FIG. 4, the controlling unit 160 may include a zero-crossing determinator 161 and a controller 162.

The zero-crossing determinator 161 may determine a zero-crossing point of the back-electromotive force. More specifically, the zero-crossing determinator 161 may apply the gradient provided from the gradient calculator 150 to an initial voltage level Vdc of the back-electromotive force (See FIG. 7). The zero-crossing determinator 161 may determine a point at which a voltage level is equal to ½ of the initial voltage level Vdc as the zero-crossing point, as a result of applying the gradient to the initial voltage level Vdc.

That is, since the zero-crossing determinator 161 may determine the zero-crossing point only using the gradient and the initial voltage level Vdc of the back-electromotive force, it may rapidly determine the zero-crossing point through a simple configuration.

The controller 162 may control the driving signal generating unit 120 to perform phase commutation using the determined zero-crossing point.

Referring to another example of FIG. 5, the controlling unit 160 may further include a delay adder 163. Another example of FIG. 5 may be applied to a case in which a filtering delay is generated by the filter 151.

The delay adder 163 may further add a time delay generated due to filtering performed by the gradient calculating unit 150 to the zero-crossing point. Since the filter 151 of the gradient calculating unit 150 has fixed characteristics, a relatively constant time delay may be generated by the filter 151. Therefore, the delay adder 163 may compensate for such a time delay. Describing this in more detail with reference to the graph of FIG. 6, a predetermined delay may be generated due to the filtering performed by the gradient calculating unit 150. Therefore, the delay adder 163 may compensate for the delay generated due to the filtering performed by the gradient calculating unit 150 to allow the zero-crossing point to be more accurately calculated.

The delay adder 163 may provide the zero-crossing point in which the delay generated due to the filtering has been compensated for, and the controller 162 may control the driving signal generating unit 120 to perform the phase commutation using the compensated zero-crossing point.

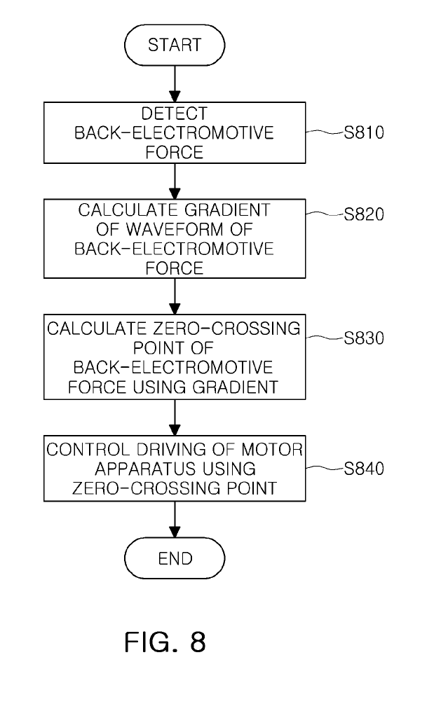

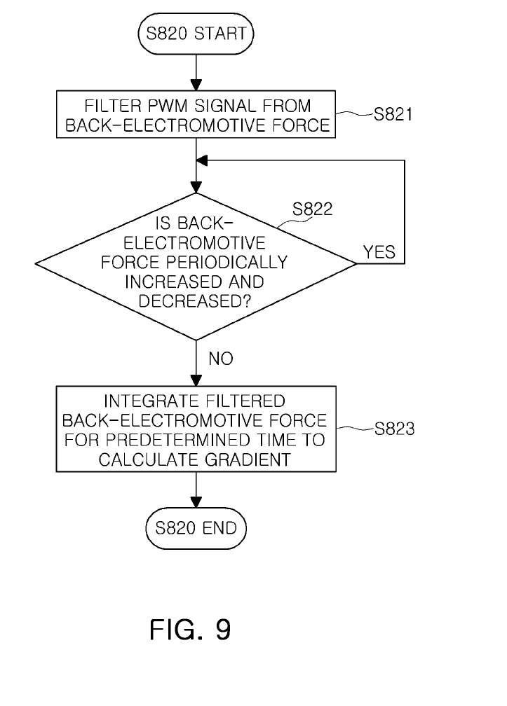

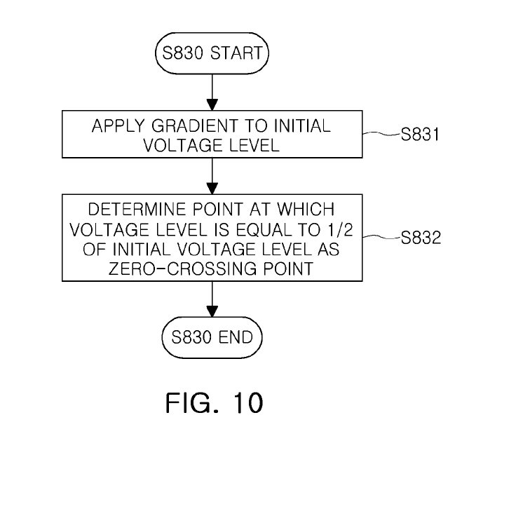

FIG. 8 is a flowchart illustrating an example of a motor driving control method according to the embodiment of the present invention; and FIGS. 9 and 10 are detailed flowcharts illustrating examples of the motor driving control method according to the embodiment of the present invention.

Hereinafter, examples of a motor driving control method according to the embodiment of the present invention will be described with reference to FIGS. 8 through 10. Since the example of the motor driving control method according to the embodiment of the present invention is performed by the motor driving control apparatus 100 described above with reference to FIGS. 2 through 7, an overlapped description of contents the same as or corresponding to the above-mentioned contents will be omitted.

Referring to FIG. 8, the motor driving control apparatus 100 may detect back-electromotive force of the motor apparatus 200 (S810). The motor driving control apparatus 100 may calculate a gradient of a waveform of the detected back-electromotive force (S820) and calculate a zero-crossing point of the back-electromotive force using the calculated gradient (S830).

The motor driving control apparatus 100 may control the driving of the motor apparatus 200 using the calculated zero-crossing point (S840).

Describing an example of the calculating of the gradient (S820) with reference to FIG. 9, the motor driving control apparatus 100 may perform filtering for removing a PWM signal from the back-electromotive force (S821). The motor driving control apparatus 100 may determine whether the back-electromotive force is periodically increased and decreased or not (S822) and integrate the filtered back-electromotive force for a predetermined time to calculate the gradient (S823) when it is determined that the back-electromotive force has a constant gradient (“NO” of S822).

In this case, the motor driving control apparatus 100 may perform the integration using the above-mentioned Equation 1 to calculate the gradient a (See FIG. 7), as described above.

Describing an example of the calculating of the zero-crossing point (S830) with reference to FIG. 10, the motor driving control apparatus 100 may apply the gradient to an initial voltage level Vdc (S831) and reflect the gradient to determine a point at which a voltage level corresponds to ½ of the initial voltage level Vdc as the zero-crossing point (S832).

As set forth above, according to embodiments of the present invention, a gradient of a waveform of back-electromotive force is simply calculated by integration, and a zero-crossing point of the back-electromotive force is calculated using the calculated gradient, whereby the driving of a motor may be more accurately and rapidly performed.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a back-electromotive force detecting unit detecting back-electromotive force of a motor apparatus;
a gradient calculating unit calculating a gradient of a waveform of the detected back-electromotive force; and
a controlling unit calculating a zero-crossing point of the back-electromotive force using the calculated gradient and controlling driving of the motor apparatus using the calculated zero-crossing point.

2. The motor driving control apparatus of claim 1, wherein the gradient calculating unit includes:
a filter removing a driving control signal from the back-electromotive force; and
an integrator integrating the filtered back-electromotive force provided from the filter for a predetermined time to calculate the gradient.

3. The motor driving control apparatus of claim 2, wherein the integrator calculates the gradient using the following Equation:
$$Vintegral = {\int }_{0}^{t} - ax + V d c = {[ - \frac{{ax}^{2}}{2} + V d cx ]}_{0}^{t} .$$

4. The motor driving control apparatus of claim 2, wherein the integrator does not calculate the gradient when the filtered back-electromotive force is periodically increased and decreased for the predetermined time.

5. The motor driving control apparatus of claim 1, wherein the controlling unit includes a zero-crossing determinator applying the gradient to an initial voltage level and determining a point at which a voltage level is equal to ½ of the initial voltage level as the zero-crossing point.

6. The motor driving control apparatus of claim 5, wherein the controlling unit further includes a delay adder adding a time delay generated due to filtering performed by the gradient calculating unit to the zero-crossing point.

7. The motor driving control apparatus of claim 1, further comprising a driving signal generating unit generating a driving control signal of the motor apparatus according to the controlling of the controlling unit,
wherein the controlling unit controls the driving signal generating unit to perform phase commutation according to the zero-crossing point.

8. A motor comprising:
a motor apparatus performing a rotation operation according to a driving control signal; and
a motor driving control apparatus providing the driving control signal to the motor apparatus to control driving of the motor apparatus,
wherein the motor driving control apparatus calculates a zero-crossing point of back-electromotive force using a gradient of a waveform of the back-electromotive force detected in the motor apparatus and generates the driving control signal using the calculated zero-crossing point.

9. The motor of claim 8, wherein the motor driving control apparatus includes:
a back-electromotive force detecting unit detecting the back-electromotive force of the motor apparatus;
a gradient calculating unit calculating the gradient of the waveform of the detected back-electromotive force; and
a controlling unit calculating the zero-crossing point of the back-electromotive force using the calculated gradient and controlling the driving of the motor apparatus using the calculated zero-crossing point.

10. The motor of claim 9, wherein the gradient calculating unit includes:
a filter removing the driving control signal from the back-electromotive force; and
an integrator integrating the filtered back-electromotive force provided from the filter for a predetermined time to calculate the gradient.

11. The motor of claim 10, wherein the integrator calculates the gradient using the following Equation:
$$Vintegral = {\int }_{0}^{t} - ax + V d c = {[ - \frac{{ax}^{2}}{2} + V d cx ]}_{0}^{t} .$$

12. The motor of claim 8, wherein the controlling unit includes a zero-crossing determinator applying the gradient to an initial voltage level and determining a point at which a voltage level is equal to ½ of the initial voltage level as the zero-crossing point.

13. A motor driving control method performed by a motor driving control apparatus controlling driving of a motor apparatus, the motor driving control method comprising:
detecting back-electromotive force of the motor apparatus;
calculating a gradient of a waveform of the detected back-electromotive force; and
calculating a zero-crossing point of the back-electromotive force using the calculated gradient and controlling the driving of the motor apparatus using the calculated zero-crossing point.

14. The motor driving control method of claim 13, wherein the calculating of the gradient includes:
performing filtering for removing a driving control signal from the back-electromotive force; and
integrating the filtered back-electromotive force for a predetermined time to calculate the gradient.

15. The motor driving control method of claim 14, wherein the integrating of the filtered back-electromotive force includes calculating the gradient using the following Equation:
$$Vintegral = {\int }_{0}^{t} - ax + V d c = {[ - \frac{{ax}^{2}}{2} + V d cx ]}_{0}^{t} .$$

16. The motor driving control method of claim 14, wherein the integrating of the filtered back-electromotive force includes allowing the gradient not to be calculated when the filtered back-electromotive force is periodically increased and decreased for the predetermined time.

17. The motor driving control method of claim 13, wherein the controlling of the driving of the motor apparatus includes applying the gradient to an initial voltage level and determining a point at which a voltage level is equal to ½ of the initial voltage level as the zero-crossing point.
